(19) United States
(12) Patent Application Publication
(10) Pub. No.: US 2015/0288117 A1
(43) Pub. Date: Oct. 8, 2015

(54) RETENTION MODULE WITH PROTECTION CAP

(71) Applicant: FOXCONN INTERCONNECT TECHNOLOGY LIMITED, Grand Caymann (KY)

(72) Inventor: CHENG-CHI YEH, New Taipei (TW)

(21) Appl. No.: 14/676,840

(22) Filed: Apr. 2, 2015

(30) Foreign Application Priority Data
Apr. 2, 2014 (TW) 103205628

(51) Int. Cl. H01R 31/00; H01R 12/70; H01R 12/72

(52) U.S. Cl. CPC H01R 31/00; H01R 12/72; H01R 12/7052

(57) ABSTRACT

A protection cap provided for a retention module of a photoelectric conversion connector assembly includes an upper wall, a plurality of supporting walls extending downwardly from the upper wall and at least one protruding portion extending downwardly from the upper wall. The protruding portion has a latch portion at a free end thereof for latching a retention plate of the retention module. The latch portion has a first inclined guiding face extending towards the free end so as to guide the retention plate to a printed circuit board.

### BACKGROUND OF THE INVENTION

1. Field of the Invention

The present invention generally relates to a retention module with a protection cap, and more particularly to a retention module being used for a photoelectric conversion connector assembly.

2. Description of Related Art

A photoelectric conversion connector is used for the transformation between optical signal and electrical signal from one to the other in a photoelectric module. The photoelectric conversion connector has a receptacle connector being installed on a printed circuit board and a retention plate disposed at one side of the receptacle connector. The printed circuit board has a plurality of holes into which protruding portions of the retention plates assembled into. In existed technology, the retention plate is directly taken to a printed circuit board by an absorb device and assembled on the printed circuit board by making the protruding portions align with the holes and be pressed down. It is always encountered that the protruding portions of the retention plate can't be accurately aligned to the holes of the printed circuit board by the absorb device which result in damage to the retention plate.

In view of the foregoing, a protection cap provided to prevent the retention plate from being damaged will be described hereinafter.

### SUMMARY OF THE INVENTION

Accordingly, an object of the present invention is to provide a retention module which has a protection cap to protect a retention plate.

In order to achieve the object set forth, a protection cap comprises an upper wall, a plurality of supporting walls extending downwardly from the upper wall and at least one protruding portion extending downwardly from the upper wall. The protruding portion has a spear-like latch portion at a free end thereof for latching an external element. The latch portion has a first inclined guiding face extending towards the free end for guiding.

In order to achieve the object set forth, a retention module used to be mounted onto a printed circuit board comprises a retention plate and a protection cap covering the retention plate. The retention plate has a base portion and at least one drawing hole extending downwardly from the base portion. The protection cap has an upper wall and at least one protruding portion downwardly extending into the at least one drawing hole. The protruding portion has a spear-like latch portion at a free end thereof passing through the drawing hole so as to latch the retention plate.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a photoelectric conversion connector assembly of the present invention;

FIG. 2 is an exploded perspective view of the photoelectric conversion connector assembly in FIG. 1;

FIG. 3 is another exploded perspective view of the photoelectric conversion connector assembly in FIG. 1;

FIG. 4 is a perspective view of a retention module of the photoelectric conversion connector assembly shown in FIG. 1;

FIG. 5 is a right view of the retention module in FIG. 4; and

FIG. 6 is a top view of the retention module in FIG. 4.

### DETAILED DESCRIPTION OF THE INVENTION

Reference will now be made in detail to the preferred embodiment of the present invention.

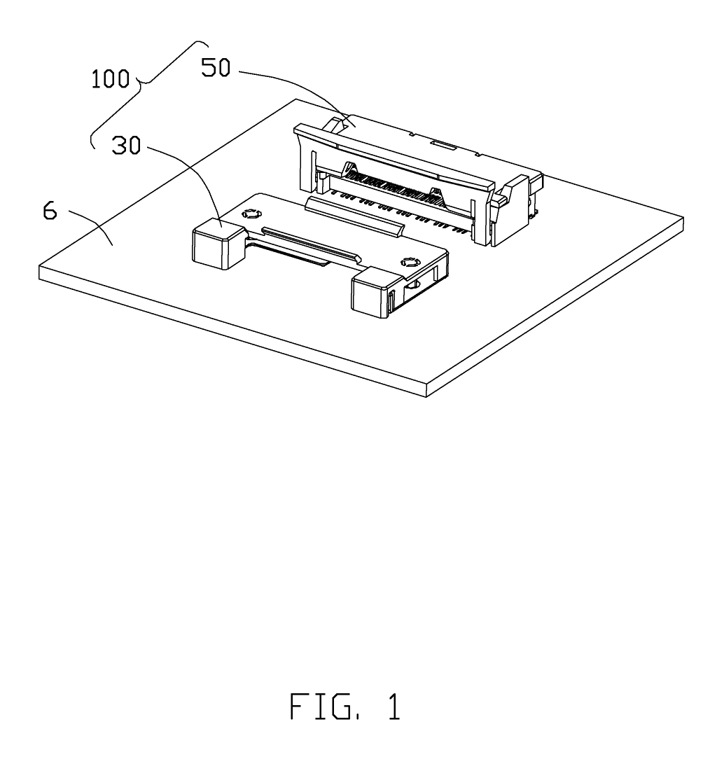

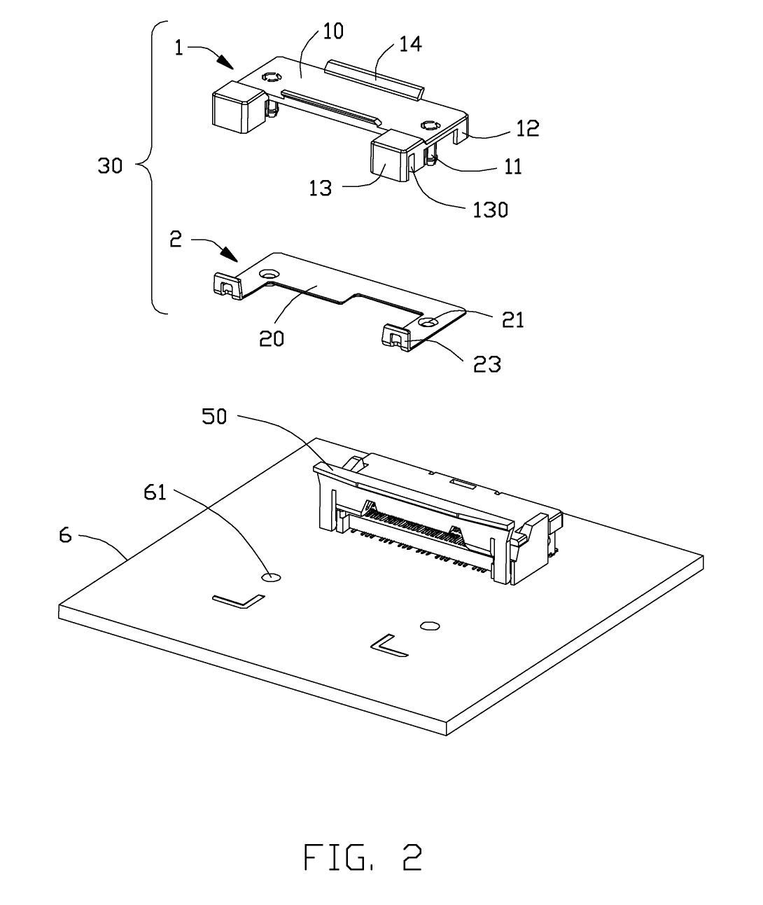

Referring to FIG. 1 and FIG. 2, the present invention provides a protection cap 1 being used for a photoelectric conversion connector assembly 100. The photoelectric conversion connector assembly 100 comprises a connector 50 mounted on a printed circuit board 6 and a retention module 30 disposed at a side of the connector 50. There is a certain distance between the connector 50 and the retention module 30. The retention module 30 has a retention plate 2 assembled on the printed circuit board 6 and a protection cap 1 covering the retention plate 2.

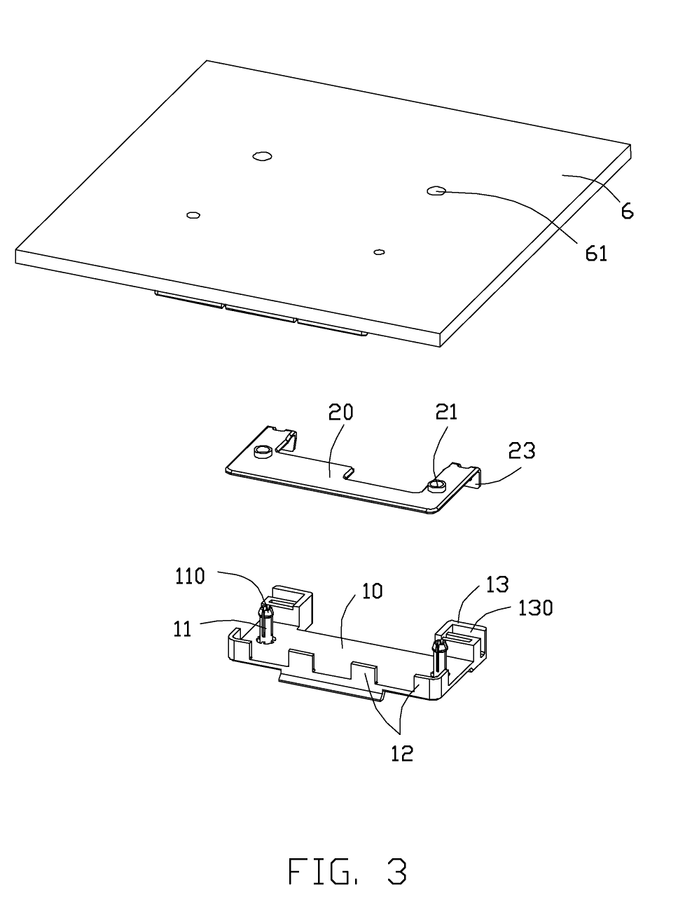

FIG. 2 and FIG. 3 will be taken to describe the protection cap 1 in detail hereinafter. The protection cap 1 has a tabulate upper wall 10 extending horizontally, a plurality of supporting walls 12 extending downwardly from the upper wall 10, two protruding portions 11 extending downwardly from the upper wall 10 and two inclined grab portions 14 extending upwardly and outwardly from edges of the upper wall 10. The supporting walls 12 are located at a peripheral area of a lower surface of the upper wall 10, the two protruding portions 11 are disposed at two ends of the lower surface of the upper wall 10 along a longitudinal direction and the two grab portions 14 are disposed at two opposite sides of an upper surface of the upper wall 10 and extend far away from each other. The protection cap 1 has two flanges 13 which extend forwardly from the supporting walls 12 and are disposed at two opposite sides with an interval space between them. The flange 13 is higher than the upper wall 10 and also can be a part of the supporting wall 12. The flange 13 each has a narrow receiving slot 130 running downwardly through a lower surface thereof and an outer side surface. The upper surface of the upper wall 10 is smooth so as to be easily absorbed by an absorb device. The two grab portions 14 extend towards two different orientations from two opposite side edges of the upper wall 10 so as to be convenient for taking the protection cap 1 off from the retention plate 2 by fingers.

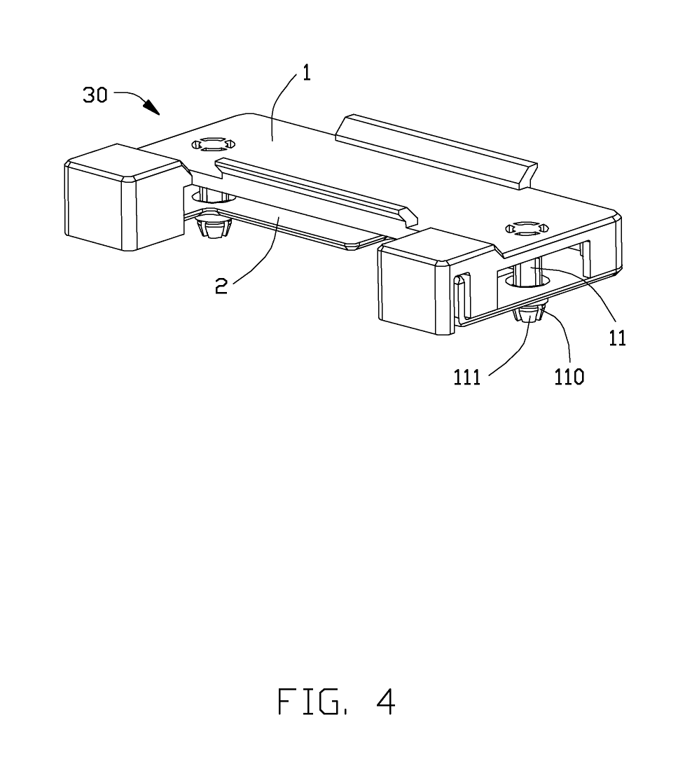

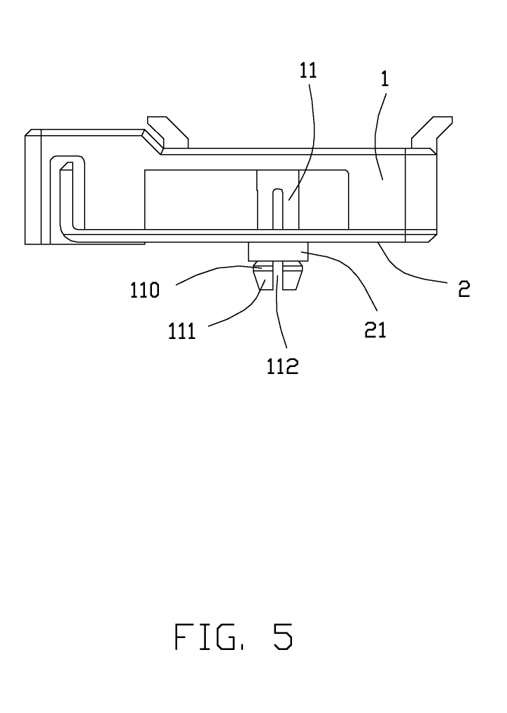

Referring to FIG. 4 and FIG. 5, a bottom of he protruding portion 11 is lower than that of the supporting wall 12. The protruding portion 11 has a spear-like latch portion 110 at a free end thereof for cooperating with the retention plate 2. The latching portion 110 is located below a bottom surface of the supporting wall 12. A sectional size of the latch portion 110 is larger than the other part of the protruding portion 11 so as to latch with the retention plate 2 and retain the retention plate 2 and the protection cap 1 together. The latch portion or guiding head 110 has a first long inclined guiding face 111 extending towards the bottom end with a sectional size thereof downwardly and gradually reduced for easily assembling the retention plate 2 to the printed circuit board 6 and a second short inclined guiding face (not labeled) extending inwardly with a sectional size thereof upwardly and gradually reduced for being easily pulled out from the retention plate 2 by users. It means that the sectional size of the latch portion 110 between the first and the second inclined guiding faces is the largest than the other part of the protruding portion 11. The protruding portion 11 has a plurality of vertical narrow slots 112 so as to divide the protruding portion 11 into several pieces and make the protruding portion 11 have the property of elastic deformation. Thus, the retention module 30 having the protection cap 1 described aforementioned is convenient for automatic production.

The retention plate 2 is a metallic thin plate and has a flat base portion 20, two drawing holes 21 extending downwardly from the base portion 20 and two bending portions 23 unitarily bending upwardly from the base portion 20. The drawing holes 21 each forms a ring-like structure connecting with the base portion 20 of the retention plate 2. The drawing holes 21 of the retention plate 2 and the protruding portion 11 of the protection cap 1 are combined with each other and are together assembled to corresponding mounting holes 61 of the printed circuit board 6. In the meanwhile, the drawing hole 21 is received in the mounting hole 61 and the bending portions 23 are upwardly received in the receiving slots 130 of the flanges 13 of the protection cap 1.

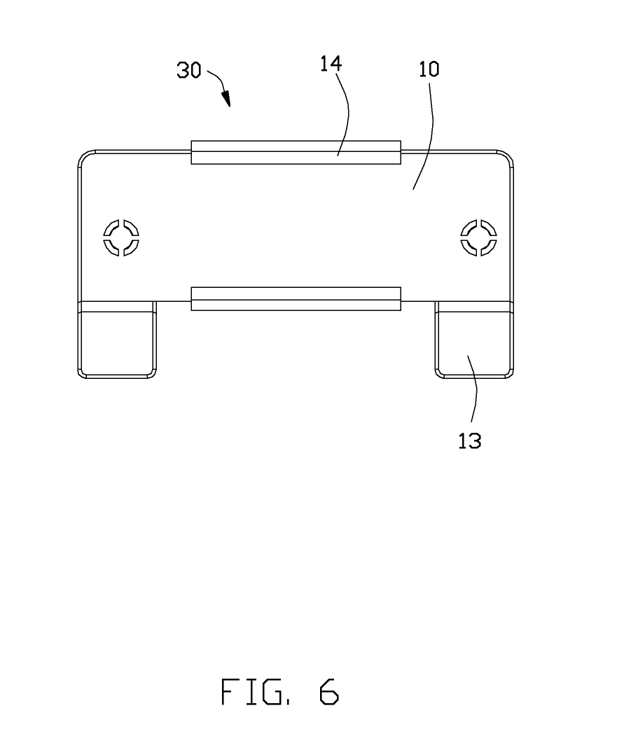

In the assembling process, the protruding portions 11 of the protection cap 1 are assembled into the corresponding drawing holes 21 of the retention plate 2. The latch portion 110 of the protruding portion 11 latch with the drawing hole 21 of the retention plate 2 to assure the retention force between the protection cap 1 and the retention plate 2 to form a retention module, thereby the supporting walls 12 of the protection cap 1 press on an peripheral area of an upper surface of the base portion 20 of the retention plate 2 so as to disperse the pressure from external along a vertical direction, and the bending portions 23 of the retention plate 2 are received in the receiving slots 130 of the flanges 13 of the protection cap 1. Then the retention module is assembled to the printed circuit board 6 with the drawing holes 21 of the retention plate 2 and the protruding portions 11 of the protection cap 1 installed into the mounting holes 61 of the printed circuit board 6. In this condition, even though the drawing holes 21 of the retention plate 2 and the mounting holes 61 of the printed circuit board 6 have deviation between them, the first guiding face 111 of the latch portion 110 of the protruding portion 11 can guide the drawing hole 21 smoothly to slide into the mounting hole 61. Referring to FIG. 6, it is easily to see that the protection cap 1 is located above and entirely covers the retention plate 2, thereby the retention plate 2 will be prevent from being damaged by any external force after the assembly. The protection cap 1 is also easily pulled out by the users because of the features of the second guiding face (clearly shown in FIG. 5).

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. A protection cap comprising:
an upper wall;
a plurality of supporting walls extending downwardly from the upper wall; and
at least one protruding portion extending downwardly from the upper wall, the protruding portion having a latch portion at a free end thereof for latching an external element, the latch portion having a first inclined guiding face extending towards the free end for guiding.

2. The protection cap as claimed in claim 1, wherein two said protruding portions are disposed at two opposite sides of a lower surface of the upper wall along a longitudinal direction, and an upper surface of the upper wall is smooth.

3. The protection cap as claimed in claim 1, wherein the latch portion is located below a bottom surface of the supporting walls.

4. The protection cap as claimed in claim 1, wherein the protruding portion has at least one narrow slot extending downwardly therethrough along a vertical direction so as to provide a transformation space for the protruding portion when being pressed by an external force.

5. The protection cap as claimed in claim 1, further comprising a pair of grab portions extending upwardly and outwardly from two opposite sides of the upper wall, the two grab portions extend far away from each other.

6. The protection cap as claimed in claim 1, further comprising two flanges, the flange extends from the supporting walls and has a receiving slot running downwardly through lower surface thereof.

7. The protection cap as claimed in claim 1, wherein the latch portion has a second inclined guiding face opposite to the first guiding face, the sectional size of the latch portion located between the first and second guiding faces is the largest and is also larger than that of the other part of the protruding portion.

8. The protection cap as claimed in claim 7, wherein the sectional size of the first guiding face is gradually reduced towards a free end direction, and the one of the second guiding face is gradually reduced towards an inner side direction, the first guiding face is longer than the second guiding face.

9. A retention module used to be mounted onto a printed circuit board comprising:
a retention plate having a base portion and at least one drawing hole extending downwardly from the base portion; and
a protection cap covering the retention plate, the protection cap having an upper wall and at least one protruding portion downwardly extending into the at least one drawing hole, the protruding portion having a spear-like latch portion at a free end thereof passing through the drawing hole so as to latch the retention plate.

10. The retention module as claimed in claim 9, wherein the drawing hole forms a ring-like structure below and connecting with the base portion, the latch portion has a first inclined guiding face extending towards a free end thereof and beyond the ring-like structure for guiding.

11. The retention module as claimed in claim 10, wherein the latch portion has a second inclined guiding face opposite to the first inclined guiding face, the second inclined guiding face is shorter than the first inclined guiding face, the sectional size of the latch portion between the first and the second inclined guiding faces is the largest and is also larger than that of the other part of the protruding portion.

12. The retention module as claimed in claim 9, wherein the protection cap has a plurality of supporting walls extending downwardly from the upper wall, the supporting walls are set on the upper surface of the base portion of the retention plate, thereby the retention plate is retained between the supporting walls and the latch portion.

13. The retention module as claimed in claim 12, wherein the protruding portion has at least one vertical slot running through an outer side surface and a lower surface thereof, the latch portion is located below a bottom surface of the supporting walls.

14. The retention module as claimed in claim 9, wherein the retention plate has a pair of bending portion unitarily being bent upwardly from one side of the base portion thereof, the supporting walls define two corresponding flanges with two receiving slots receiving the corresponding bending portions.

15. The retention module as claimed in claim 9, wherein an upper surface of the upper wall is smooth, the protection cap has two opposite grab portions extending upwardly and outwardly from two opposite side edges of the upper wall, the two grab portions extend far away from each other.

16. The retention module as claimed in claim 9, wherein the protection cap entirely covers the retention plate taken from a top view.

17. A retention module assembly comprising:
a retention plate defining a drawing hole with a dimension adapted to be received within a through hole of a printed circuit board and a downward extension adapted to extend into the through hole; and
a pick-up cap having a plate for suction, and a downward protruding portion with a guiding head at a bottom end, the protruding portion extending through the drawing hole and the guiding head extending downwardly beyond a bottom edge of the drawing hole; wherein
the retention plate is detachably retained to and pick-up cap, and the guiding head is tapered with a tip end for easy insertion into the through hole of the printed circuit board.

18. The retention module assembly as claimed in claim 17, wherein the guiding head is diametrically shrinkable so as to retain the drawing hole in position temporarily in a coaxial manner.

19. The retention module assembly as claimed in claim 17, wherein the plat covers the retention plate in a vertical direction.

20. The retention module assembly as claimed in claim 17, wherein said retention plate further includes an upward bending portion, and the pick-cup cap includes a receiving slot to protectively receive said bending portion therein.
